(19) United States
(12) Patent Application Publication
(10) Pub. No.: US 2018/0350131 A1
(43) Pub. Date: Dec. 6, 2018

(54) VECTOR REPRESENTATION FOR VIDEO SEGMENTATION

(71) Applicant: Google Inc., Mountain View, CA (US)

(72) Inventors: Irfan Essa, Atlanta, GA (US); Vivek Kwatra, Sunnyvale, CA (US); Matthias Grundmann, Atlanta, GA (US)

(21) Appl. No.: 14/587,420

(22) Filed: Dec. 31, 2014

Related U.S. Application Data
(60) Provisional application No. 61/922,192, filed on Dec. 31, 2013.

(51) Int. Cl. G06T 15/10

(52) U.S. Cl. CPC G06T 15/10

(57) ABSTRACT

Methods, systems, and apparatus, including computer programs encoded on computer storage media, for video segmentation. One of the methods includes receiving a digital video; performing hierarchical graph-based video segmentation on at least one frame of the digital video to generate a boundary representation for the at least one frame; generating a vector representation from the boundary representation for the at least one frame of the digital video, wherein generating the vector representation includes generating a polygon composed of at least three vectors, wherein each vector comprises two vertices connected by a line segment, from a boundary in the boundary representation; linking the vector representation to the at least one frame of the digital video; and storing the vector representation with the at least one frame of the digital video.

### CROSS REFERENCE TO RELATED APPLICATIONS

This application claims the benefit under 35 U.S.C. § 119(e) of the filing date of U.S. Provisional Patent Application No. 61/922,192, for Vector Representation for Video Segmentation, which was filed on Dec. 31, 2013, and which is incorporated here by reference.

### BACKGROUND

This specification relates to video segmentation.

Conventional video segmentation may produce a representation of a digital video based on spatio-temporal regions in the digital video. A spatio-temporal region may be a region of a digital video that exhibits coherence in appearance and motion across time as the digital video is played back. For example, in a digital video of an ice skater, the ice skater may be represented as one spatio-temporal region, and the ice may be represented by another spatio-temporal region. Spatio-temporal regions may be linked across frames of the digital video, so that, for example, the ice skater is represented by the same region even as the ice skater, and the region, moves and changes shape. This region-based representation may be useful in computer vision applications, as the various spatio-temporal regions of the digital video may be examined instead of the individual pixels of the digital video.

Conventional techniques for storing a region based representation produced by video segmentation may be problematic. One storage format may store region data for each pixel for each frame of the digital video. Run length encoding may be used to compress the region based representation, but the size of the data may still be prohibitive for use of the region based representation in certain applications, such as sending the region based representation over the internet. Further, the region based representation may be tied to the video resolution of the digital video used to produce the representation. If the video segmentation algorithm is run on a 1080p video, the region based representation produced may only be useful with the digital video at 1080p resolution. It may be difficult to scale the region based representation up or down to match a change in the resolution of the digital video, for example, if the digital video is scaled down for internet streaming.

To reduce the storage needed for a region based representation, only the boundaries of the spatio-temporal regions in each frame may be stored. Storing only the boundaries in a boundary representation may allow for a more efficient storage of the region based representation, but still may not scale with changes in video resolution. The boundaries may be stored based on pixel locations in each frame of the digital video at the resolution used to create the boundary representation, making it difficult to use the boundary representation with the digital video at a different resolution.

### SUMMARY

In general, one innovative aspect of the subject matter described in this specification can be embodied in methods that include the actions of receiving a digital video; performing hierarchical graph-based video segmentation on at least one frame of the digital video to generate a boundary representation for the at least one frame; generating a vector representation from the boundary representation for the at least one frame of the digital video, wherein generating the vector representation includes generating a polygon composed of at least three vectors, wherein each vector comprises two vertices connected by a line segment, from a boundary in the boundary representation; linking the vector representation to the at least one frame of the digital video; and storing the vector representation with the at least one frame of the digital video. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Generating the vector representation further includes generating polygons from all of the boundaries in the boundary representation, each polygon comprised of at least three vectors, to generate a watertight polygon mesh. A first one of the polygons shares a vector with a second one of the polygons. Storing the vector representation further includes: storing two-dimensional coordinates of each unique vertex comprising the vectors in the watertight polygon mesh in a vertex mesh, wherein each unique vertex is assigned an index in the vertex mesh; and storing the index for each unique vertex in the vertex mesh in a polygon table. The method further includes: changing the size of the polygons in the watertight polygon mesh to match a change in resolution of the at least one frame of the digital video including multiplying each dimension of the two-dimensional coordinates of each vertex in the vertex mesh by a factor that is equal to a factor of the change in the resolution of the at least one frame of the digital video.

The method further includes merging a plurality of polygons from the watertight polygon mesh that include a super-region of the at least one frame of the digital video to create a polygon for the super-region. Merging the plurality of polygons that comprise the super-region includes: determining one or more vectors that are shared between at least two polygons in the super-region; discarding the one or more vectors that are shared between at least two polygons in the super-region; and creating a polygon from the non-discarded vectors. Generating a polygon composed of at least three vectors from a boundary is controlled by an error measurement, wherein the number of vertices in the watertight polygon mesh has an inverse relationship to a magnitude of the error measurement and wherein the error measurement is given in pixels. Generating polygons from all of the boundaries in the boundary representation to generate a watertight polygon mesh includes optimizing the location of the vertices by moving at least one vertex. The method further includes: increasing the size of the polygons in the watertight polygon mesh to match an increase in the resolution of the at least one frame of the digital video.

The method further includes: decreasing the size of the polygons in the watertight polygon mesh to match a decrease in the resolution of the at least one frame of the digital video. The method further includes: linking a visual annotation to a first polygon in the vector representation; displaying the at least one frame of the digital video; and displaying the visual annotation in a location of the at least one frame of the digital video based upon a location of the first polygon in the vector representation. Storing the vector representation comprises storing hierarchical data for the polygons in the watertight polygon mesh. The method includes: presenting at least a portion of the digital video to a user; receiving, from the user, an indication of a region displayed in the at least a portion of the digital video; identifying a polygon that includes the indicated region; and highlighting the identified polygon in the presented digital video. The method includes: receiving a user input to adjust the size of the highlighted polygon; based upon a hierarchy established for the polygons, identifying a super-region to which the identified polygon belongs; and highlighting additional polygons in the super-region. The method further includes: merging the highlighted polygon and the additional highlighted polygons to form a polygon for the super-region.

In general, one innovative aspect of the subject matter described in this specification can be embodied in methods that include the actions of receiving a boundary representation of a digital video created by hierarchical graph-based video segmentation, wherein the boundary representation comprises segments, and wherein each segment is defined by a boundary; generating a polygon comprised of at least three vectors, wherein each vector comprises two vertices connected by a line segment, from each boundary for each of the segments in the boundary representation; combining the polygons into a watertight polygon mesh; and storing the watertight polygon mesh as a vector representation, wherein the vector representation is linked to the digital video. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. Segments of the boundary representation are spatio-temporally linked across the frames of the digital video, and wherein the spatio-temporal linkage is preserved in the vector representation. Storing the watertight polygon mesh as the vector representation includes: for each frame of the digital video, storing two-dimensional coordinates of each unique vertex comprising the vectors in the watertight polygon mesh for the frame of the digital video in a vertex mesh, wherein each unique vertex is assigned an index in the vertex mesh; and storing, for each vector in the watertight polygon mesh for each frame in the digital video, the index in the vertex mesh for the two vertices comprising the vector in a vertex table. The vector representation is linked to the video including associating the vertex mesh and vertex table for each frame of the digital video with the frame of the digital video. The method further includes: receiving a selection of a portion of an image comprising a frame of the digital video; determining a polygon in the watertight polygon mesh that is correlated to the selected portion of the image comprising the frame of the digital video; receiving an instruction to change a visual characteristic of the portion of the image comprising the frame of the digital video; and altering the two-dimensional coordinates of the vertices for the polygon in the vertex mesh for the frame of the digital video to change the visual characteristic of the image comprising the frame of the digital video according to the received instruction. The method includes: after determining the polygon in the watertight polygon mesh that is correlated to the selected portion of the image comprising the frame of the digital video, determining additional polygons associated with a super-region correlated to the selected portion of the image comprising the frame of the digital video; and merging the polygons into a polygon for the super-region, wherein altering the two-dimensional coordinates of the vertices for the polygon in the vertex mesh for the frame alters the polygon for the super-region. The method includes altering the two-dimensional coordinates of the vertices for the polygon in the vertex mesh for additional frames of the digital video to change the visual characteristic of the images comprising the additional frames of the digital video to correlate to the change to the visual characteristic of the image comprising the frame for which the selection was received. The method includes changing the size of the polygons in the watertight polygon mesh to match a change in resolution of the digital video by multiplying each dimension of the two-dimensional coordinates of each vertex in the vertex mesh for each frame of the digital video by a factor that is equal to a factor of change in the resolution of the digital video.

The subject matter described in this specification can be implemented in particular embodiments so as to realize one or more of the following advantages. A representation for spatio-temporal regions in a digital video that can be stored and transmitted efficiently and scaled to match changes in video resolution is described.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

FIG. 1 shows an example system suitable for generating a vector representation.

FIG. 2 shows an example visualization of a boundary representation for a frame of digital video.

FIG. 3 shows an example visualization of vector representation for a frame of digital video.

FIG. 4 shows an example storage format for a frame of a vector representation.

FIG. 5 shows an example process for generating a vector representation for a digital video.

FIG. 6 shows an example annotation positioned using a vector representation for a digital video.

FIG. 7 shows an example visualization of a frame of digital video edited using a vector representation.

FIG. 8 shows an example visualization of merging polygons using a vector representation.

FIG. 9 shows an example computer.

FIG. 10 shows an example network configuration.

Like reference numbers and designations in the various drawings indicate like elements.

### DETAILED DESCRIPTION

A representation for spatio-temporal regions in a digital video that can be stored, transmitted, and scaled to match changes in video resolution may be useful in a number of applications. In some implementations, hierarchal graph-based video segmentation is be used to generate a boundary representation of a digital video by generating a boundary representation for each frame of the digital video. In the boundary representation for a frame, a spatio-temporal region in the frame of the digital video can be stored based on the location of the pixels that define the boundary of the spatio-temporal region. The spatio-temporal regions in a frame may also be hierarchical, with super regions that are made up of smaller regions. For example, an ice skater can be represented by a super region made of spatio-temporal regions for the ice skater's appendages, torso, and head and neck. The hierarchical graph-based video segmentation can produce watertight boundaries where each boundary in the boundary representation for a frame of the digital video is either shared between neighboring spatio-temporal regions or runs along an edge of the frame. In some implementations, there are no double boundaries, or boundaries that are between neighboring regions but are not shared. The spatio-temporal regions can be spatio-temporally linked across frames of the digital video.

In some implementations, the boundary representation of the digital video are vectorized to generate a vector representation of the digital video. Each frame of the boundary representation can be used to generate a vector representation for each frame of the digital video. A boundary for a spatio-temporal region in the boundary representation can be used to generate a polygon in the vector representation. The polygon generated from a boundary can be defined by three or more vectors aligned with the contours of the boundary. A vector in the polygon can be defined by two vertices, which may include a horizontal and vertical, or x and y, position within the frame of the video. The number of vectors used to create the polygon for a boundary can be adjustable so that the polygon can follow the contours of the boundary with any suitable level of accuracy.

The polygons in the vector representation for a frame of the digital video can form a watertight polygon mesh, where each vector is either shared by polygons in neighboring spatio-temporal regions, or runs along the edge of the frame. In some implementations, the vector representation for a frame preserves the hierarchy of the boundary representation for the frame, with each polygon inheriting the hierarchy position of the boundary used to generate the polygon.

In some implementations, the vector representation for the digital video, which can include a watertight polygon mesh for each frame of the digital video, is stored by storing the horizontal and vertical position of each vertex of the watertight polygon mesh in an indexed vertex mesh. Additionally, indices into the vertex mesh for each vector of a polygon in the watertight polygon mesh can be stored in a polygon table. In some implementations, an entry for a polygon in the polygon table includes a list of indices, with one index for each vertex in the polygon. The indices can indicate which vertices stored in the vertex mesh form each vector of the polygon, and may be stored in counterclockwise order. The hierarchy of the polygons can also be stored.

In some implementations, the vector representation for the digital video is scaled along with the digital video, regardless of the resolution the digital video had when the vector representation was created. The vector representation for the digital video can be scaled by multiplying the coordinates of the vertices in the vertex mesh by the same factor as the change in video resolution. For example, if the digital video is doubled in resolution from when the vector representation was created, the vector representation can be scaled up by doubling the value of each of the coordinates of the vertices stored in the vertex mesh for the vector representation for each frame. Similarly, if the resolution of the digital video is cut in half, the vertex coordinates can be also be cut in half. This may allow the vector representation for the digital video to be used regardless of the resolution of the digital video, without requiring the generation of a new vector representation for each new resolution.

The vector representation for a digital video can be used to assist in the manipulation of the digital video, for example, editing the digital video e.g., by annotating or changing one or more visual characteristics of the digital video. An annotation can appear as, for example, boxes or other visual items displayed over or as part of the video during playback, and can contain, for example, images, text, and/or hyperlinks. An annotation can be linked to a polygon in the vector representation, allowing the location of the annotation to be linked to the spatio-temporal region represented by the polygon.

For example, in a digital video of an ice skater, an annotation can be linked to the polygon in the vector representation for the video that represents the spatio-temporal region of the ice skater's right leg. The annotation can be set to appear to the left of the ice skater's right leg. Using the vector representation for the digital video, the location of the skater's right leg can be determined in each frame of the digital video. The right leg may change size and position across frames of the digital video. Because the polygons for the right leg's spatio-temporal regions are linked across frames in the vector representation, the annotation can be overlaid on the video in an appropriate position based on the position of the polygon for the ice skater's right leg in each frame of the digital video, regardless of any changes in size and/or position which may occur over time.

During video editing, a portion of the image in a frame of the digital video can be selected by a user for manipulation. The selected portion of the image can be correlated to a polygon in the vector representation for the frame of the video. For example, the user may select the right leg of the ice skater in a frame of the digital video. The selection can be correlated to the polygon for the right leg of the ice skater in the vector representation for the frame. The user can input a change to some visual characteristic of the selected portion of the image, e.g., location, size, or color. When a size, shape, or other similar characteristic is modified, one or more polygons correlated with the portion of the image can be modified by changing the coordinates of the vertices for the polygon in accordance with the change in visual characteristic input by the user.

This edited polygon can change the shape and location of the region within the frame. The image in the frame of video that was contained within the unedited polygon can then be modified using any suitable image processing techniques to fill in the shape of the edited polygon. For example, the user can input a change to increase the size of the ice skater's right leg. The vertices of the polygon for the right leg can be moved farther apart to correspond to the input change in size. The image of the ice skater's right leg in the frame, as was bounded by the unedited polygon, can then be changed to fill in the shape of the edited polygon. A change in the shape of a polygon in a vector representation for a frame can be propagated to other frames of the vector representation.

In some implementations, when a portion of the image in a frame of the digital video is selected, the user intends to manipulate a super region associated with the selected portion of the image, rather than just the region for the selected portion. For example, the selection of the ice skater's right leg may be intended as a selection of the entire ice skater. In this case, after a correlated polygon has been determined for the selection, a super region associated with the correlated polygon can also be determined using the hierarchy for the polygons. The polygons in the super region can be merged, and the resulting polygon for the super region can be modified to generate a change in visual characteristic input by the user for the image in the super region. The user can be provided with a mechanism to alter the level of polygon hierarchy associated with a selection, for example, a slider or scroll wheel manipulation, which allows the user to indicate which polygon hierarchy, and thus which region(s) or super region(s), are desired for inclusion in the selection.

Continuing the specific example above, a user may select an ice skater's right leg, and subsequently manipulate an appropriate interface to increase or decrease the selected region or super region. For example, the user may decrease the selected region to include only a subset of the skater's leg, such as the right skate, or increase the selected region to include a super region, such as the skater's entire body. As described in further detail below, such selections and selection changes may correspond to traversing the polygon hierarchy in each direction.

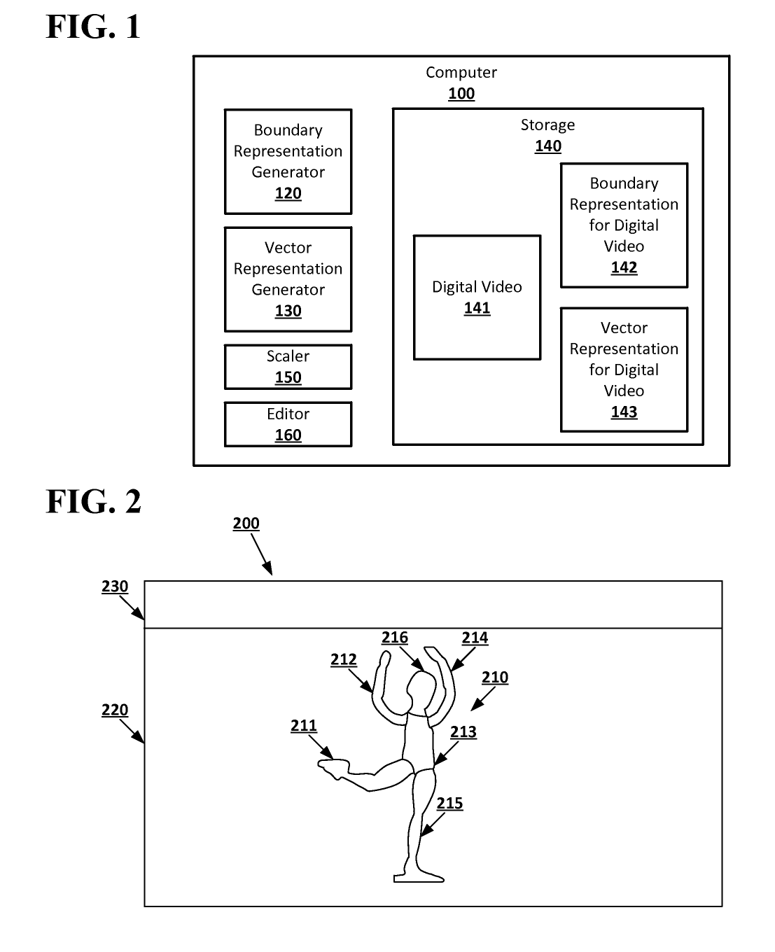

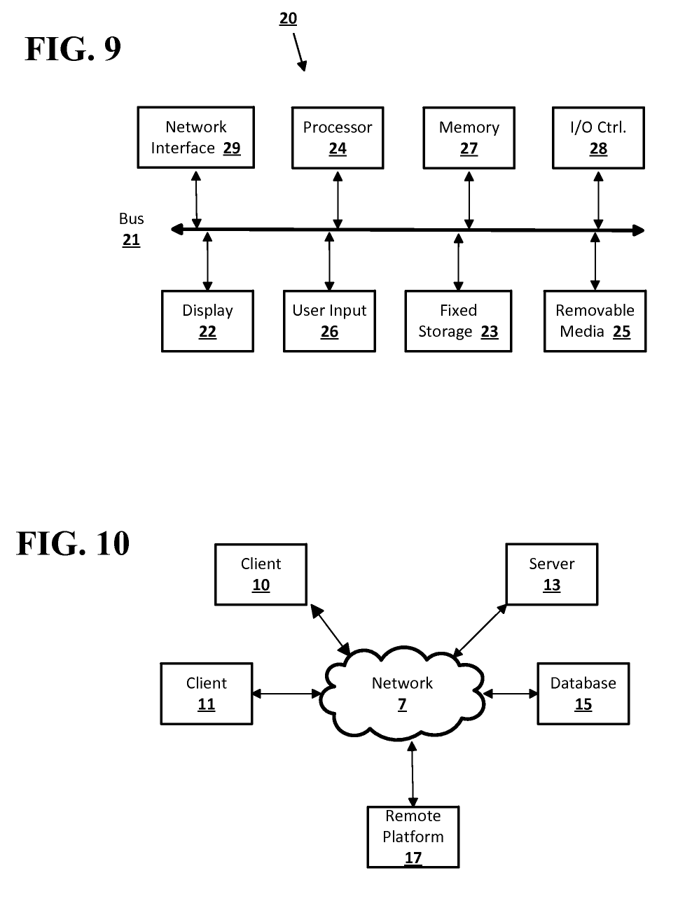

FIG. 1 shows an example system suitable for generating a vector representation. A computer 100 includes a boundary representation generator 120, a vector representation generator 130, storage 140, scaler 150, and editor 160. The computer 100 can be any suitable computing device, for example, a computer 20 as described below in FIG. 9, for implementing the boundary representation generator 120, the vector representation generator 130, and the storage 140. The computer 100 can be a single computing device or can include multiple connected computing devices.

The boundary representation generator 120 receives a digital video 141, which can be a digital video in any suitable format and encoding, from the storage 140, and generates a boundary representation 142 for the digital video 141. The boundary representation 142 for the digital video 141 can be generated, for example, using hierarchical graph-based video segmentation. The vector representation generator 130 can receive the boundary representation 142 for the digital video 141 and generate a vector representation 143 for the digital video 141. The database 140 stores the digital video 141, the boundary representation 142 for the digital video 141, and the vector representation 143 for the digital video 141. The scaler 150 is configured to scale the vector representation 143 for the digital video 141 to match a change in resolution of the digital video 141. The editor 160 uses the vector representation 143 for the digital video 141 to edit images in frames of the digital video 141.

FIG. 2 shows an example visualization of a boundary representation 200 for a frame of a digital video. The boundary representation 200 for the frame of the digital video, e.g., digital video 141 of FIG. 1, can be the result of processing the frame of the digital video with hierarchical graph-based video segmentation, for example, by a boundary representation generator, e.g., boundary representation generator 120 of FIG. 1. The hierarchical graph-based video segmentation divides the frame of the digital video into separate spatio-temporal regions, and creates a watertight mesh of boundaries and a hierarchy for the spatio-temporal regions. For example, a boundary 212 encompasses a region with the ice skater's right arm, a boundary 214 encompasses the ice skater's left arm, a boundary 211 encompasses the ice skater's right leg, a boundary 215 encompasses the ice skater's left leg, a boundary 213 encompasses the ice skater's torso, and a boundary 216 encompasses the ice skater's head and neck. These boundaries may be part of a super region, which is represented by the boundary 210 encompassing the entirety of the ice skater. Another boundary 220 encompasses the ice, excluding the ice skater, and a boundary 230 encompasses the portion of the boards visible at the top of the frame.

The boundary representation for the frame may be over-segmented by hierarchical graph-based video segmentation. The frame of the digital video can be divided into many spatio-temporal regions with the various spatio-temporal regions linked according to the hierarchy into super regions that may correspond better to parts of the image a user may attempt to manipulate.

The spatio-temporal regions can be linked across frames of the digital video, such that, for example, the boundary 211 for the ice skater's right leg in one frame of the digital video is linked to the boundary for the ice skater's right leg in the next frame of the digital video, even if the size, shape, and location of the image of the leg has changed between frames.

Because the boundary representation for the frame may be a watertight mesh, parts of the boundaries may be shared. For example, the boundary 220 for the ice includes parts of the boundaries 211, 212, 213, 214, 215, 216, and 230, in locations where the region for the ice neighbors the region for those boundaries. In some implementations, for each pixel in one of the boundaries, the regions adjacent to the pixel may be determined, allowing for shared boundaries.

The boundary representation for the frame may be created for some or all of the frames of the digital video, with spatio-temporal regions linked between the boundary representations for each frame. The boundary representations for some or all of the frames in the digital video may form the boundary representation for the digital video. The boundary representation for the digital video can be stored as part of the video data or separately, using any suitable format, including, for example, pixel by pixel or raster format with or without run-length encoding. In some implementations, the boundary representation for the digital video can be generated from the digital video at a specified resolution. In some other implementations, the boundary representation for the digital video is tied to the resolution of the digital video, and may not be scalable to represent the digital video if the resolution of the digital video is changed.

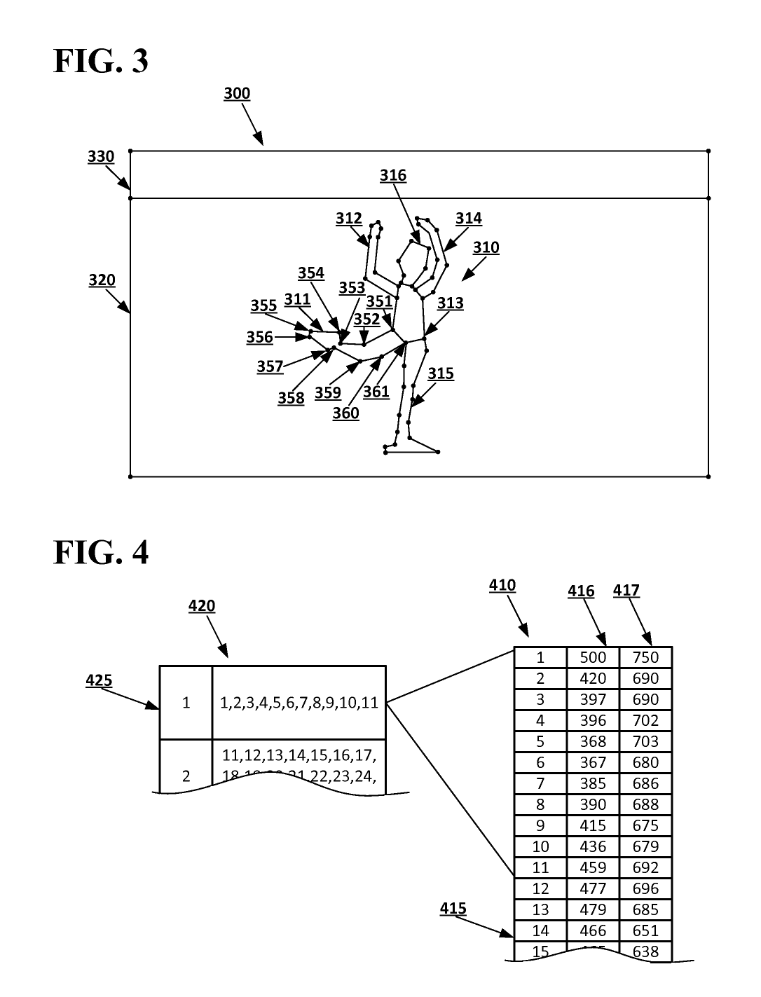

FIG. 3 shows an example visualization of a vector representation 300 for a frame of digital video. The boundary representation for the frame of the digital video, e.g., boundary representation 200, can be used to generate the vector representation 300 for the frame of the digital video, for example, by a vector representation generator, e.g., vector representation generator 130 of FIG. 1. Each boundary from the boundary representation, for example, the boundaries 211, 212, 213, 214, 215, 216, 220, and 230 shown in FIG. 2, may be used to generate a non-self-intersecting polygon including at least three vectors.

Each vector in the polygon may be defined by two vertices, and the first and last vertex in a polygon may be the same vertex to ensure the polygon is closed. For example, the boundary 211 for the ice skater's right leg may be used to generate a polygon 311 having vertices 351, 352, 353, 354, 355, 356, 357, 358, 359, 360, and 361. The vectors of the polygon 311 may be between consecutively labeled vertices except for one vector, which may have vertices 351 and 361. Hierarchies may be preserved from the boundary representation for the frame. For example, polygons 311, 312, 313, 314, 315, and 316 may form the super region of the polygon 310, which may be the polygon formed by the outer edges of its constituent polygons. The hierarchy for the polygon 310 may be inherited from the hierarchy for the boundary 210. This may preserve the hierarchal structure from the boundary representation for the frame.

In some implementations, the number of vectors used to create the polygon for a boundary is adjustable so that the polygon can follow the contours of the boundary with a suitable level of accuracy. For example, as shown in FIG. 3, the polygon 311 includes 11 vectors. If a higher level fidelity to the boundary 216, and the shape of the region in the image from the frame of the digital video, is needed, the number of vectors used to create the polygon 311 may be increased. As more vectors are used, the vectors may more closely recreate the original boundary 216.

An error level used in converting a boundary into a polygon may be measured in pixels. Vertices for the polygons may be moved to allow the polygons to better fit the contours of the boundaries. For example, the Ramer-Douglas-Peucker algorithm may be modified to optimize the placement of vertices by examining all of the vertices for all of the polygons. Once all of the polygons have been generated for a frame of the digital video, any of the vertices may be moved to obtain a more optimal fit between the polygons and the boundaries.

Polygons in the vector representation 300 for the frame can form a watertight polygon mesh, where each vector in a polygon in the watertight polygon mesh is either shared between two polygons or incident to a boundary of the frame. For example, the polygons 311, 312, 313, 314, 315, 316, 320, and 330 form a watertight polygon mesh for the frame of the video, with no double boundaries and no areas of the image in the frame that are not contained within one of the polygons 311, 312, 313, 314, 315, 316, 320, and 330. Polygons within the watertight polygon mesh may share vectors to avoid double boundaries. For example, the vector formed by vertices 351 and 361 is shared between the polygon 311 and the polygon 313 for the ice skater's torso. The polygon 320, for the ice, shares vectors with the polygons 311, 312, 313, 314, 315, 316, and 330.

A region contained within a boundary in the boundary representation for a frame may include a hole. The hole is a boundary contained entirely within another boundary. When drawing the vector representation, the polygon for a hole may be drawn after the polygon for the boundary containing the hole. Similarly, if a point-in-polygon-test is performed on the vector representation for a frame, holes may need to be tested before the polygons containing the holes. Polygons that are holes may be flagged as holes during the generation of the vector representation for a frame. Additionally, each polygon may be stored with a list of one or more other polygons that are a hole in the polygon. This information may be used to recursively determine the draw order of the polygons in the vector representation for a frame.

FIG. 4 shows an example storage format for a frame of a vector representation. A vector representation for a frame, e.g., the vector representation 300, may be created for some or all of the frames of a digital video e.g., digital video 141, with the links between spatio-temporal regions preserved from the boundary representations, forming a vector representation for the digital video. The vector representation for the digital video, e.g., vector representation 143, can be stored as part of the video data or separately.

For each vector representation for a frame in the vector representation for the digital video, the 2-dimensional coordinates of each vertex in the watertight polygon mesh may be stored in a vertex mesh 410. The vertex mesh 410 may be, for example, a table, matrix, or array. Each vertex has an entry 415 in the vertex mesh 400. Each entry 415 includes coordinates for a particular vertex, specifically, an x-coordinate 416 and a y-coordinate 417, which together locate the particular vertex within the frame.

The entry 415 may be identified by an index. For example, the vertices 351, 352, 353, 354, 355, 356, 357, 358, 359, 360, and 361 may each have a separate indexed entry 415 in the vertex mesh 410. Each of the entries 415 include an x-coordinate 416 and a y-coordinate 417 locating each of the vertices 351, 352, 353, 354, 355, 356, 357, 358, 359, 360, and 361, respectively, within the frame of the digital video used to generate the vector representation for the frame. There may be a separate vertex mesh 410 for each frame of the digital video.

A polygon in the vector representation for a frame may be stored as a list of indices into the vertex mesh 410. The stored indices point to the entries 415 for the vertices defining the vectors that form the polygon. For example, the polygon 316 shown in FIG. 3 may be stored as a list of indices 1, 2 3, 4, 5, 6, 7, 8, 9, 10, and 11, which may be the indices for the entries 415 for the corresponding vertices 351, 352, 353, 354, 355, 356, 357, 358, 359, 360, and 361 in the vertex mesh 410. The indices can be listed in counterclockwise order, or in clockwise order for polygons flagged as holes, and the last vector in a polygon may be a vector between the first and last listed vertices. The list of indices into the vertex mesh 410 can be stored in a polygon table 420, which may include an entry 425 for each polygon. The polygon table 420 may also include hierarchal data for the polygons, flagging for polygons that are holes, and data linking the spatio-temporal regions contained in the polygons to counterpart spatio-temporal regions in the vector representations for other frames of the digital video. The example storage format shown in FIG. 4 is illustrative, and that other specific formats and arrangements may be used to store equivalent data.

Storing the vector representation for the digital video using a vertex mesh 410 and a polygon table 420 may require significantly less storage than storing the boundary representation for the digital video. Further, it may allow for more efficient processing of the digital video. For example, GPU-accelerated polygon rasterizers may require as input a vertex array and a list of indices into the vertex array describing the primitives to be rendered, so the vector representation for a frame of the digital video is stored in a proper format for rendering. Additionally, using a pair of indices to represent a vertex in the polygon table 420 allows for more efficient hashing of the vectors, which may be useful, for example, when locating interior vectors in a super region.

In some implementations, the boundary representation for the digital video used to generate the vector representation for the digital video has been generated from the digital video at a certain initial video resolution. The vector representation for the digital video may not be tied to the initial video resolution, or to any other particular resolution of the digital video. For example, the boundary representation for the digital video can be generated from the digital video with a resolution of 360p. The vector representation for the digital video may be generated from the 360p boundary representation for the digital video, but may be used with the digital video at any resolution, whether higher or lower than the 360p resolution. This may reduce the computational complexity of creating the vector representation for the digital video, as the boundary representation for the digital video may be created from a low resolution digital video and then used to generate the vector representation for the digital video, which may be used with the digital video at a higher resolution.

The vector representation for the digital video may be scaled, using, for example, a scaler, e.g., the scaler 150, by multiplying the coordinates of the vertices in the vertex mesh 410 for each vector representation for a frame by the same factor as the change in video resolution. For example, if the resolution of the digital video used in generating the vector representation for the digital video is doubled, the x coordinate 416 and y coordinate 417 may be doubled at each entry 415 in each vertex mesh 410 for each vector representation for the frames of the digital video. This scales up the vector representation to match the increased resolution of the digital video.

In some implementations, the vector representation for a frame is linked to a particular frame of the digital video that the vector representation for a frame was generated from. The link may be based on, for example, a particular frame number of the frame. Linking the vector representation for the frame to the particular frame of the digital video may allow the vector representation for the digital video to be used in conjunction with the digital video. For example, the linking may be used to allow for editing or annotation of the digital video or visual rendering of the vector representation for the digital video over the digital video during playback. For example, during playback of the digital video, a user may select a region in the image of the displayed frame, and the polygon for the region in the vector representation for the frame may be rendered and highlighted or just highlighted if the polygons are already rendered. The highlighting may also be applied to the polygons in other frames to which the highlighted polygon is spatio-temporally linked as the digital video is further played or reversed.

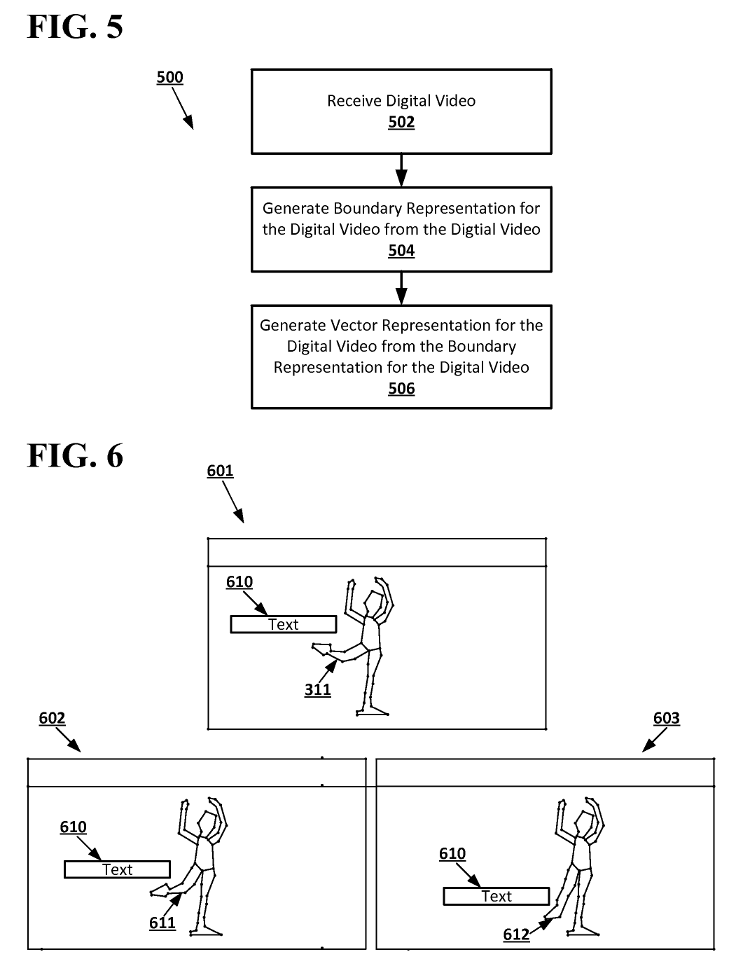

FIG. 5 shows an example process 500 for generating a vector representation for a video. For convenience, the process 500 will be described as being performed by a system of one or more computers, located in one or more locations, and programmed appropriately in accordance with this specification. For example, a computer system, e.g., the computer 100 of FIG. 1, appropriately programmed, can perform the process 500.

The system receives a digital video (502). For example, a boundary representation generator, e.g., boundary representation generator 120, can receive the digital video from storage, e.g., the storage 140.

The system generates a boundary representation for the digital video (504). For example, the boundary representation generator may generate the boundary representation, e.g., boundary representation 142, for the digital video. The boundary representation generator can use, for example, hierarchical graph-based video segmentation to generate a boundary representation for a frame of the digital video by over-segmenting the frame, and then locating the boundaries between the segments, forming a watertight mesh. The boundary representation for the video may include a boundary representation for a frame for each frame of the digital video.

The system generates a vector representation for the digital video (506). For example, a vector representation generator, e.g., the vector representation generator 130, can receive the boundary representation for the video from the storage, or directly from the boundary representation generator. The vector representation generator can generate a vector representation for a frame by generating a polygon for each boundary in a boundary representation for the frame, forming a watertight polygon mesh. The vector representation generator can generate a vector representation for the frame for each boundary representation for a frame in the boundary representation for the digital video. The vector representation for the digital video may be stored in the storage along with the digital video.

FIG. 6 shows an example annotation 610 positioned using a vector representation for a digital video. The annotation 610 can be added to one or more frames of the digital video using, for example, an editor, e.g., the editor 160 of FIG. 1. The vector representation for a digital video may be used to position the annotation 610 in frames of the digital video. The annotation 610 can be a visual item, e.g., block containing text, that was not part of the original digital video, but was added to the digital video. The annotation 610 can be added to the digital video, for example, by a user, in such a way that it can appear or not appear when the digital video is viewed, depending on, for example, a user preference. The annotation 610 does not alter the images within the frames of the digital video, but instead can be rendered on top of the images during viewing of the digital video.

In some implementations, the position of the annotation 610 is based on the position of a specific spatio-temporal region in the digital video, so that the annotation 610 appears in some position relative to the position of that spatio-temporal region across frames of the digital video. The position for the annotation 610 may be selected, for example, by a user adding the annotation 610 to the digital video. The position of the annotation 610 may be linked to a particular spatio-temporal region in the digital video by basing the position of the annotation 610 on the position of the polygon for the spatio-temporal region in the vector representations for the frames of the digital video in which the annotation 610 appears.

For example, referring to the previous example of an ice skater, the user can add the annotation 610 to the digital video and select to base the position of the annotation 610 on the ice skater's right leg. The user may select the ice skater's right leg, and input a starting position for the annotation 610 above and to the left of the right leg in a first frame 601 of the digital video. To properly position the annotation 610 in a second frame 602 and a third frame 603, the polygon representing the ice skater's right leg may be determined for the frames 601, 602, 603. This determination may be made using the spatio-temporal linkage of polygons across the vector representations for the frames.

In the first frame 601, the polygon 311 may represent the ice skater's right leg. The polygon 311 is spatio-temporally linked to the polygon 611 in the second frame, and to the polygon 612 in the third frame. The user selected position of the annotation 610 relative to the polygon 311 in the first frame is determined, and is used to position the annotation relative to the polygons 611 and 612. The result can be positioning coordinates for the annotation 610 for the second frame 602 and the third frame 603. When the digital video is viewed with the annotation 610, the annotation 610 may be rendered on top of the images in the frames 601, 602, and 603 using the positioning coordinates, so that the annotation 610 maintains the desired position relative to the image of the ice skater's right leg.

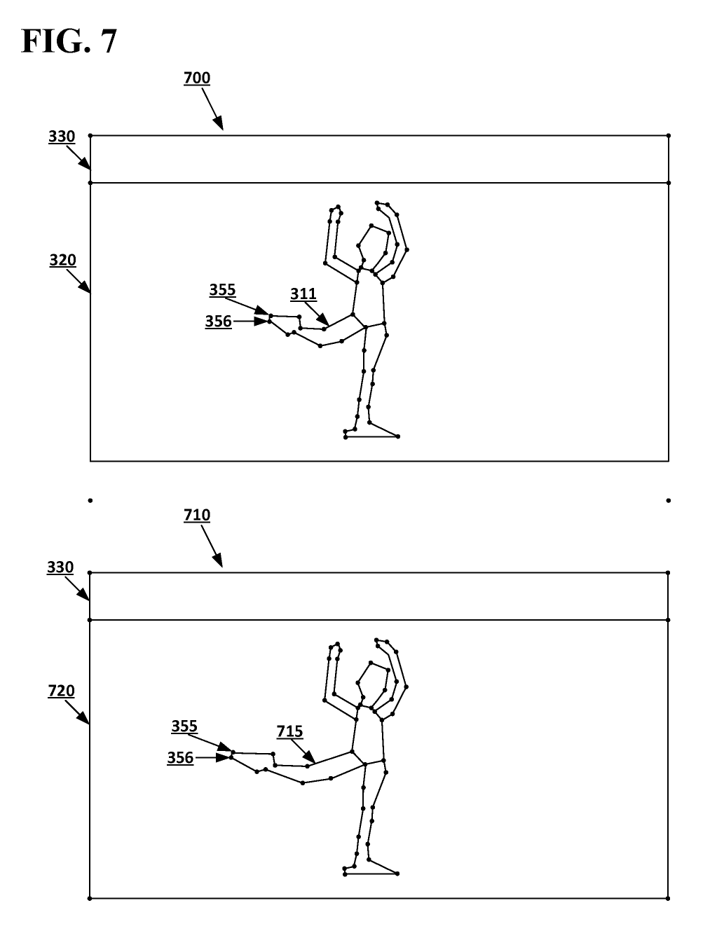

FIG. 7 shows an example visualization of a frame of video edited using a vector representation. The digital video may be edited using an editor, e.g., the editor 160, using a vector representation, e.g., the vector representation 143, for the digital video. Visual characteristics of the image in frames of the digital video, for example, size, shape, and location, can be modified. The modifications can be made as the result of, for example, user inputs. To edit a particular frame of the digital video, a polygon in the vector representation for the frame can be manipulated, for example, by changing the x-coordinates and the y-coordinates in the vertex mesh for vertices of the polygon, thereby changing the size, shape, or location of the polygon within the frame, which results in an edited polygon. The part of the image in the frame enclosed by the unedited polygon may then be changed to match the edited polygon.

For example, a user may wish to elongate the right leg of the ice skater. The user may select the right leg of the ice skater in a frame 700 of the digital video and input an increase in size for the right leg. The polygon 311 is determined to be correlated with the region for the right leg selected by the user. The input change can be implemented by changing the x-coordinates and the y-coordinates in the vertex mesh for the vertices in the polygon 311. For example, the vertices 355 and 356 can be moved toward a left edge of the frame 700, and the other vertices adjusted in kind. This results in an edited polygon 715 in an edited frame 710. The part of the image in the frame that was bounded by the polygon 311 is changed to match the edited polygon 715, for example, by stretching the image out to match the stretching of the polygon 311 into the edited polygon 715. Editing the polygon 311 into the polygon 715 also results in the polygon 320 for the ice being changed to the polygon 720 in the edited frame 710 since the polygon 311 and the polygon 320 share vectors and vertices. Thus, a change to the any of the shared vectors and vertices when editing the polygon 311 also affects the shape of the polygon 320.

A change made to one polygon in a vector representation 300 for a frame can be propagated to the vector representation for additional frames in the digital video. For example, the user may input that the ice skater's right leg should be elongated across multiple frames of the digital video. Polygons in the vector representations for the additional frames that are spatio-temporally linked to the polygon 311 can be changed in a manner similar to the polygon 311, resulting in the user's edit being propagated to the additional frames.

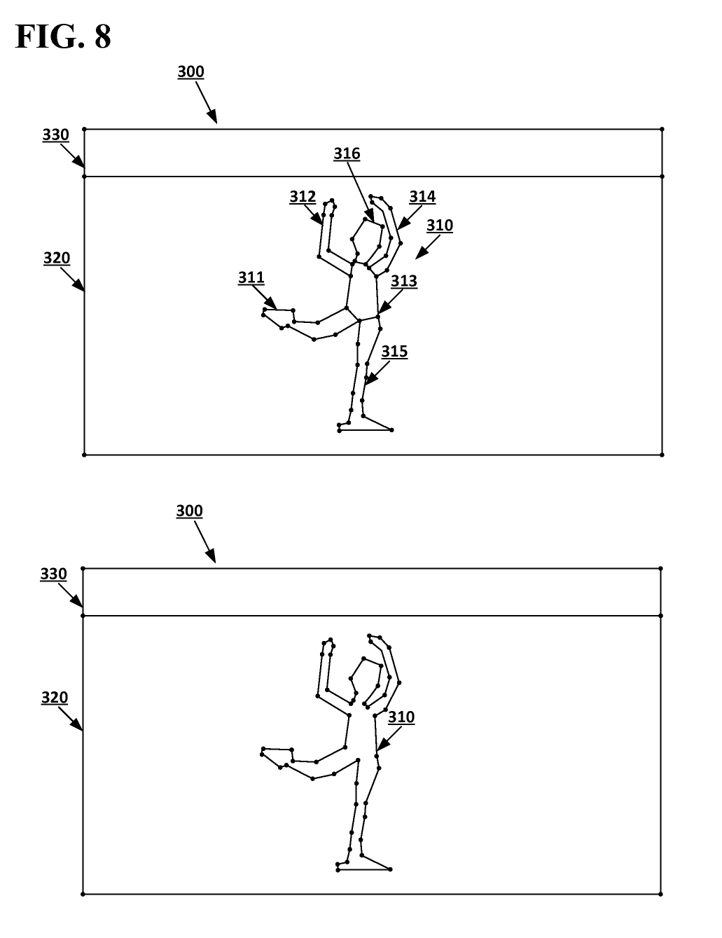

FIG. 8 shows an example visualization of merging polygons using a vector representation. The vector representation for a frame may only store polygons for over-segmented regions in a vertex mesh e.g., the vector mesh 410 and a polygon table, e.g., the polygon table 420. In some implementations, a polygon for a super-region is also used. The polygon for a super-region can be generated by merging polygons that make up the super-region according to the hierarchal data stored, for example, in the polygon table.

For example, the polygons 311, 312, 313, 314, 315, and 316 can form the super region of the polygon 310, which may encompass the entirety of an ice skater. A user editing the digital video may, as described with reference to FIG. 7, select the image of the right leg of the ice skater in frame. The user may edit not just the image of the right leg, but the image of the entirety of the ice skater. This may be determined based on context, or based on input from the user. To use the vector representation for the frame to edit the entirety of the image of the ice skater, the polygons 311, 312, 313, 314, 315, and 316 may need to be merged to create the polygon 310 for the super region. The polygon 310 may then be edited as described above with respect to FIG. 7. For example, instead of elongating the right leg of the ice skater by editing the polygon 311, as in FIG. 7, the size of the entire ice skater may be increased by editing the polygon 310 after merging the polygons 311, 312, 313, 314, 315, and 316.

To merge polygons into a polygon for a super region, the inside vectors of the polygons can be discarded, and the remaining vectors form the polygon for the super region. Inside vectors can be vectors shared by any two of the polygons being merged into the polygon for the super region. For example, any vectors shared among the polygons 311, 312, 313, 314, 315, and 316 are discarded to create the polygon 310. Inside vectors can be determined in any suitable manner. For example, all of the vectors in the polygons 311, 312, 313, 314, 315, and 316 can be gathered from the vertex mesh and polygon table for the vector representation for the frame into a vector list. Duplicate entries in the vector list may indicate an inside vector, and may be located by, for exampling applying a hash function to the vector list. Any vectors from the vector list that collide when hashed may be inside vectors, and may be discarded. Vectors remaining in the vector list can be ordered in a counterclockwise traversal, for example, using shared vertices to determine how the remaining vectors are connected, and stored as the polygon 310.

Embodiments of the presently disclosed subject matter may be implemented in and used with a variety of component and network architectures. FIG. 9 is an example computer 20. For example, the computer 20 may be used to implement the computer 100 shown in FIG. 1. The computer 20 includes a bus 21 that interconnects major components of the computer 20, e.g., a central processor 24, a memory 27 (typically RAM, but which may also include ROM, flash RAM, or the like), an input/output controller 28, a user display 22, such as a display screen using a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable storage medium, e.g., a hard disk drive (e.g., fixed storage 23), an optical drive, floppy disk, or other storage medium 25. For example, the boundary representation generator 120, the vector representation generator 130, the scaler 150, the editor 160, and the storage 140 including the digital video 141, the boundary representation 142, and the vector representation 143, may reside in the fixed storage 23 or the removable media component 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 10.

Many other devices or components (not shown) may be connected in a similar manner (e.g., document scanners, digital cameras and so on). Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, removable media 25, or on a remote storage location.

FIG. 10 shows an example network arrangement. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. For example, the computer 100 including the machine learning system 110 may be implemented in a server 13, and the input source 420 may be one of the clients 10, 11, with access to the computer 100 through the network 7.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible computer readable storage media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

What is claimed is:

1. A method comprising:
receiving a digital video;
performing hierarchical graph-based video segmentation on at least one frame of the digital video to generate a boundary representation for the at least one frame, wherein the boundary representation includes a plurality of boundaries, and wherein each boundary of the boundary representation:
encompasses a particular spatio-temporal region, wherein each spatio-temporal region corresponds to a region of the video that exhibits coherence in appearance and motion across time over a plurality of frames of the digital video,
wherein the particular spatio-temporal region corresponds to one or more objects in the video frame, and
wherein the boundary is at least partially shared with another boundary of a different spatio-temporal region of the video frame;
generating a vector representation from the boundary representation for the at least one frame of the digital video, wherein generating the vector representation includes generating a polygon for each boundary of the boundary representation corresponding to an outline of a respective spatio-temporal region, wherein each polygon is composed of at least three vectors, and wherein each vector of the polygon comprises two vertices connected by a line segment corresponding to a portion of the boundary;
linking the vector representation to the at least one frame of the digital video; and
storing the vector representation with the at least one frame of the digital video.

2. The method of claim 1, wherein generating the vector representation further comprises generating polygons from all of the boundaries in the boundary representation, each polygon comprised of at least three vectors, to generate a watertight polygon mesh.

3. The method of claim 2, wherein a first one of the polygons shares a vector with a second one of the polygons.

4. The method of claim 3, wherein storing the vector representation further comprises:
storing two-dimensional coordinates of each unique vertex comprising the vectors in the watertight polygon mesh in a vertex mesh, wherein each unique vertex is assigned an index in the vertex mesh; and
storing the index for each unique vertex in the vertex mesh in a polygon table.

5. The method of claim 4, further comprising:
changing the size of the polygons in the watertight polygon mesh to match a change in resolution of the at least one frame of the digital video including multiplying each dimension of the two-dimensional coordinates of each vertex in the vertex mesh by a factor that is equal to a factor of the change in the resolution of the at least one frame of the digital video.

6. The method of claim 4, further comprising:
merging a plurality of polygons from the watertight polygon mesh that comprise a super-region of the at least one frame of the digital video to create a polygon for the super-region.

7. The method of claim 6, where merging the plurality of polygons that comprise the super-region comprises:
determining one or more vectors that are shared between at least two polygons in the super-region;
discarding the one or more vectors that are shared between at least two polygons in the super-region; and
creating a polygon from the non-discarded vectors.

8. The method of claim 2, wherein the generating a polygon composed of at least three vectors from a boundary is controlled by an error measurement, wherein the number of vertices in the watertight polygon mesh has an inverse relationship to a magnitude of the error measurement and wherein the error measurement is given in pixels.

9. The method of claim 2, wherein generating polygons from all of the boundaries in the boundary representation to generate a watertight polygon mesh further comprises moving at least one vertex so that each polygon substantially fits contours of the corresponding boundary.

10. The method of claim 2, further comprising:
increasing the size of the polygons in the watertight polygon mesh to match an increase in the resolution of the at least one frame of the digital video.

11. The method of claim 2, further comprising:
decreasing the size of the polygons in the watertight polygon mesh to match a decrease in the resolution of the at least one frame of the digital video.

12. The method of claim 2, further comprising:
linking a visual annotation to a first polygon in the vector representation;
displaying the at least one frame of the digital video; and
displaying the visual annotation in a location of the at least one frame of the digital video based upon a location of the first polygon in the vector representation.

13. The method of claim 2, wherein storing the vector representation comprises storing hierarchical data for the polygons in the watertight polygon mesh.

14. The method of claim 1, comprising:
presenting at least a portion of the digital video to a user;
receiving, from the user, an indication of a region displayed in the at least a portion of the digital video;
identifying a polygon that includes the indicated region; and
highlighting the identified polygon in the presented digital video.

15. The method of claim 14, comprising:
receiving a user input to adjust the size of the highlighted polygon;
based upon a hierarchy established for the polygons, identifying a super-region to which the identified polygon belongs; and
highlighting additional polygons in the super-region.

16. The method of claim 15, further comprising:
merging the highlighted polygon and the additional highlighted polygons to form a polygon for the super-region.

17. A method comprising:
receiving a boundary representation of a digital video created by hierarchical graph-based video segmentation on at least one frame of the digital video, wherein the boundary representation for each frame comprises a plurality of boundaries, wherein each boundary:
includes a plurality of segments that define the boundary of a particular spatio-temporal region, and
encompasses a particular spatio-temporal region, wherein each spatio-temporal region corresponds to a region of the video that exhibits coherence in appearance and motion across time over a plurality of frames of the digital video,
wherein the particular spatio-temporal region corresponds to one or more objects in the video frame, and
wherein the boundary is at least partially shared with another boundary of a different spatio-temporal region of the video frame
generating a polygon comprised of at least three vectors, wherein each vector comprises two vertices connected by a segment, from each boundary of the boundary representation corresponding to an outline of a respective spatio-temporal region, wherein each polygon is formed from the segments that define the corresponding boundary in the boundary representation;
combining the polygons into a watertight polygon mesh for the frame of the digital video; and
storing the watertight polygon mesh as a vector representation, wherein the vector representation is linked to the digital video.

18. The method of claim 17, wherein the segments of the boundary representation are spatio temporally linked across the frames of the digital video, and wherein the spatio-temporal linkage is preserved in the vector representation.

19. The method of claim 17, wherein storing the watertight polygon mesh as the vector representation comprises:
for each frame of the digital video, storing two-dimensional coordinates of each unique vertex comprising the vectors in the watertight polygon mesh for the frame of the digital video in a vertex mesh, wherein each unique vertex is assigned an index in the vertex mesh; and
storing, for each vector in the watertight polygon mesh for each frame in the digital video, the index in the vertex mesh for the two vertices comprising the vector in a vertex table.

20. The method of claim 19, wherein the vector representation is linked to the video including associating the vertex mesh and vertex table for each frame of the digital video with the frame of the digital video.

21. The method of claim of 19, further comprising:
receiving a selection of a portion of an image comprising a frame of the digital video;
determining a polygon in the watertight polygon mesh that is correlated to the selected portion of the image comprising the frame of the digital video;
receiving an instruction to change a visual characteristic of the portion of the image comprising the frame of the digital video; and
altering the two-dimensional coordinates of the vertices for the polygon in the vertex mesh for the frame of the digital video to change the visual characteristic of the image comprising the frame of the digital video according to the received instruction.

22. The method of claim 21, comprising:
after determining the polygon in the watertight polygon mesh that is correlated to the selected portion of the image comprising the frame of the digital video, determining additional polygons associated with a super-region correlated to the selected portion of the image comprising the frame of the digital video; and
merging the polygons into a polygon for the super-region, wherein altering the two-dimensional coordinates of the vertices for the polygon in the vertex mesh for the frame alters the polygon for the super-region.

23. The method of claim 21, comprising altering the two-dimensional coordinates of the vertices for the polygon in the vertex mesh for additional frames of the digital video to change the visual characteristic of the images comprising the additional frames of the digital video to correlate to the change to the visual characteristic of the image comprising the frame for which the selection was received.

24. The method of claim 19, comprising changing the size of the polygons in the watertight polygon mesh to match a change in resolution of the digital video by multiplying each dimension of the two-dimensional coordinates of each vertex in the vertex mesh for each frame of the digital video by a factor that is equal to a factor of change in the resolution of the digital video.

25. A system comprising:
one or more computers and one or more storage devices storing instructions which are operable, when executed by the one or more computers, to cause the one or more computers to perform operations comprising:
receiving a digital video;
performing hierarchical graph-based video segmentation on at least one frame of the digital video to generate a boundary representation for the at least one frame, wherein the boundary representation includes a plurality of boundaries, and wherein each boundary of the boundary representation:
encompasses a particular spatio-temporal region, wherein each spatio-temporal region corresponds to a region of the video that exhibits coherence in appearance and motion across time over a plurality of frames of the digital video,
wherein the particular spatio-temporal region corresponds to one or more objects in the video frame, and
wherein the boundary is at least partially shared with another boundary of a different spatio-temporal region of the video frame;
generating a vector representation from the boundary representation for the at least one frame of the digital video, wherein generating the vector representation includes generating a polygon for each boundary of the boundary representation corresponding to an outline of a respective spatio-temporal region, wherein each polygon is composed of at least three vectors, and wherein each vector of the polygon comprises two vertices connected by a line segment corresponding to a portion of the boundary;
linking the vector representation to the at least one frame of the digital video; and
storing the vector representation with the at least one frame of the digital video.

26. A method comprising:
receiving a digital video;
generating, for each frame of the digital video, a vector representation from a boundary representation for the frame, the boundary representation including a plurality of boundaries wherein each boundary:
encompasses a particular spatio-temporal region, wherein each spatio-temporal region corresponds to a region of the video that exhibits coherence in appearance and motion across time over a plurality of frames of the digital video,
wherein the particular spatio-temporal region corresponds to one or more objects in the video frame, and
wherein the boundary is at least partially shared with another boundary of a different spatio-temporal region of the video frame wherein generating the vector representation includes generating one or more polygons, each polygon corresponding to a boundary of the boundary representation, wherein each polygon is composed of at least three vectors that from a particular boundary of the boundary representation for the frame; and
manipulating the digital video using the vector representation.

27. The method of claim 26, wherein the manipulating includes annotating the digital video.

28. The method of claim 27, wherein annotating comprises:
linking a visual annotation to a first polygon in the vector representation;
displaying the at least one frame of the digital video; and
displaying the visual annotation in a location of the at least one frame of the digital video based upon a location of the first polygon in the vector representation.

29. The method of claim 26, wherein the manipulating includes editing the digital video to change one or more visual characteristics of an image in one or more frames of the digital video.

30. The method of claim 29, comprising:
receiving a selection of a portion of an image comprising a frame of the digital video;
determining a polygon that is correlated to the selected portion of the image comprising the frame of the digital video;
receiving an instruction to change a visual characteristic of the portion of the image comprising the frame of the digital video; and
altering the two-dimensional coordinates of the vertices for the polygon to change the visual characteristic of the image comprising the frame of the digital video according to the received instruction.

31. The method of claim 30, comprising:
altering the two-dimensional coordinates of the vertices for the polygon for additional frames of the digital video to change the visual characteristic of the images comprising the additional frames of the digital video to correlate to the change to the visual characteristic of the image comprising the frame.

32. The method of claim 26, wherein manipulating includes changing a resolution of the digital video, and wherein changing the resolution of the digital video includes scaling the vector representation.

33. The method of claim 32, wherein scaling the vector representation comprises:
increasing the size of the one or more polygons to match an increase in the resolution of the at least one frame of the digital video.

34. The method of claim 32, wherein scaling the vector representation comprises:
decreasing the size of the one or more polygons to match a decrease in the resolution of the at least one frame of the digital video.
